(19) United States
(12) Patent Application Publication
(10) Pub. No.: US 2017/0306092 A1
(43) Pub. Date: Oct. 26, 2017

(54) BENZOXAZINE COMPOUND

(71) Applicant: NIPPON KAYAKU KABUSHIKI KAISHA, Tokyo (JP)

(72) Inventors: Tsutomu TAKEICHI, Aichi (JP); Tsubasa OHSAWA, Aichi (JP); Takuto MORI, Toyama (JP); Kazunori ISHIKAWA, Tokyo (JP); Koju IWASAKI, Tokyo (JP)

(73) Assignee: NIPPON KAYAKU KABUSHIKI KAISHA, Tokyo (JP)

(21) Appl. No.: 15/465,974

(22) Filed: Mar. 22, 2017

(30) Foreign Application Priority Data
Apr. 4, 2016 (JP) 2016-075059

(51) Int. Cl. C08G 73/02; C08G 73/06; C08J 5/24; C08K 5/13

(52) U.S. Cl. CPC C08G 73/0233; C08K 5/13; C08G 73/0688; C08J 5/24; C08L 2203/12

(57) ABSTRACT

Problem to be Solved

One of the objects of the resent invention is to provide a new polybenzoxazine compound that can afford a cured product having excellent toughness, heat resistance and flame retardance without using other components together.

Solution

A benzoxazine compound represented by formula (1):

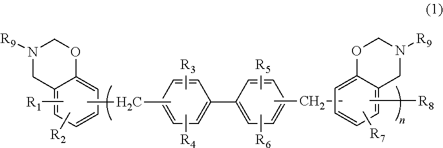

wherein n is an average repeating number and represents a real number of 1 to 5; R₁ to R₈ each independently represent a hydrogen atom, a halogen atom, an alkyl group having a carbon number of 1 to 8 or an aryl group; when n is 2 or more and the number of each R₃ to R₇ is 2 or more, each R₃ to R₇ may be the same or different; and R₉ represents a residue of a monoamine compound from which an amino group is removed.

### TECHNICAL FIELD

The present invention relates to a new benzoxazine compound from which the cured product are obtained has excellent toughness and heat resistance.

### BACKGROUND ART

Because the cured product of a benzoxazine compound synthesized from phenols, amines and aldehydes has excellent heat resistance and flame retardance, it is expected that the benzoxazine compound can be applied in various uses such as a laminating board for a printed wiring board and a semiconductor sealing material. In order to obtain the desired characteristics in these uses, various examinations on the new benzoxazine compounds, compositions using the benzoxazine resin and methods for producing the benzoxazine compounds are conducted.

Patent Literature 1 describes that a benzoxazine compound from which the cured product is obtained has flame retardance improved by specifying the range of the number average molecular weight.

Patent Literature 2 describes that a benzoxazine compound from which the cured product is obtained has flame retardance improved by synthesizing phenols, amines and aldehydes in a specific solvent at a specific temperature.

Patent Literature 3 describes that a benzoxazine compound into which liquid crystal properties are imparted by introducing a specific partial structure so as to improve the orientation at the curing.

However, in the above literature, no solution to the problems that the cured product of a benzoxazine compound essentially has low toughness, i.e. a benzoxazine compound is a brittle material are described.

Patent Literature 4 describes a resin composition for a fiber reinforcement composite material comprising a benzoxazine compound, an epoxy resin, a sulfonic acid ester and a thermoplastic resin, which is intended to solve the problems described above. The composition described in Patent Literature 4 can improve toughness of the fiber reinforcement composite material, but the composition is unsuitable for electricity and electronic fields such as a laminating board for a printed wiring board and a semiconductor sealant, because the heat resistance and the flame retardance which the benzoxazine originally has are deteriorated by the influence of the thermoplastic resin contained in said composition. The benzoxazine compound that can afford a cured product having excellent toughness without using other components together is required still now.

### CITATION LIST

### Patent Literature

Patent Literature 1: JP 2001-278934 A

Patent Literature 2: JP 2004-352670 A

Patent Literature 3: JP 2013-056863 A

Patent Literature 4: JP 2015-522092 A

### SUMMARY OF INVENTION

### Technical Problem

In view of the circumstances described above, the present invention has been achieved. An object of the present invention is to provide a new polybenzoxazine compound that can afford a cured product having excellent toughness, heat resistance and flame retardance without using other components together.

### Solution to Problem

From the results of diligent studies, the inventors have found that the aforementioned problems were solved by using the benzoxazine compound having a specific structure to accomplish the present invention. That is, the present invention is as follows.

[1] A benzoxazine compound represented by formula (1):

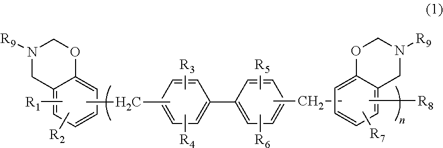

wherein, n is an average repeating number and represents a real number of 1 to 5; R₁ to R₈ each independently represent a hydrogen atom, a halogen atom, an alkyl group having a carbon number of 1 to 8 or an aryl group; when n is 2 or more and the number of each R₃ to R₇ is 2 or more, each R₃ to R₇ may be the same or different; and R₉ represents a residue of a monoamine compound from which an amino group is removed.

[2] The benzoxazine compound according to item [1], represented by formula (2):

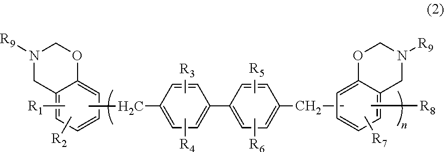

wherein, n and R₁ to R₉ represent the same as n and R₁ to R₉ in formula (1) described in item [1],

[3] the benzoxazine compound according to item [1] or [2], wherein R₁ to R₈ are hydrogen atoms,

[4] the benzoxazine compound according to any one of items [1] to [3], wherein R₉ is a residue of an aromatic monoamine compound from which an amino group is removed,

[5] a varnish comprising the benzoxazine compound according to any one of items [1] to [4] and a solvent,

[6] a cured product of the benzoxazine compound according to any one of items [1] to [4], and

[7] A method for producing the benzoxazine compound represented by formula (1) described in item [1] comprising the step of:

reacting a phenolic compound represented by formula (3):

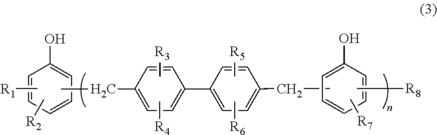

wherein, n and R₁ to R₈ represent the same as n and R₁ to R₈ in formula (1) described in item [1],

with a monoamine compound represented by formula (4):

R₉—NH₂ (4)

wherein, R₉ represent the same meaning as R₉ in formula (1) described in item [1],

and an aldehyde compound.

### Advantageous Effects of Invention

The present invention can provide a new benzoxazine compound having excellent toughness and heat resistance without using other components together.

### BRIEF DESCRIPTION OF DRAWINGS

FIG. 1 shows the ¹H NMR spectrum of the biphenyl phenol condensation type novolac resin (phenolic compounds) used in Example 1.

FIG. 2 shows the ¹H NMR spectrum of the benzoxazine compound obtained in Example 1.

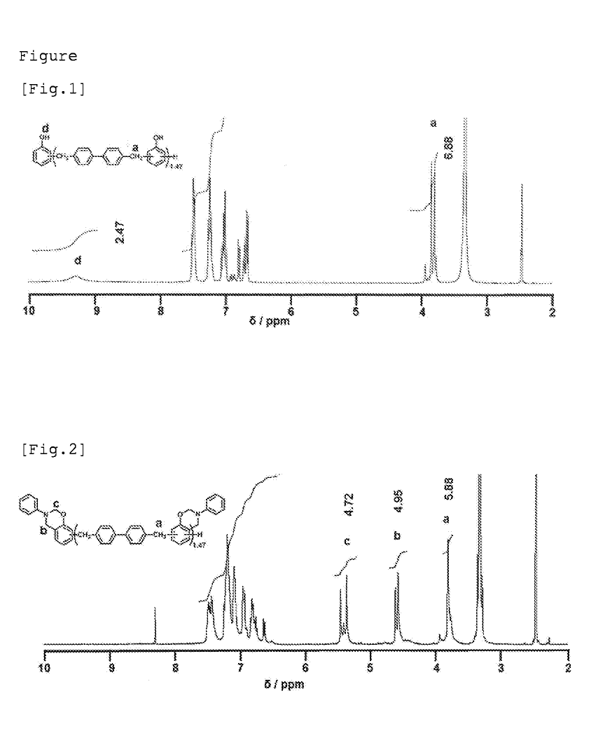

### DESCRIPTION OF EMBODIMENTS

Hereinafter, the present invention is described in detail. The following explanation on the constituents is based on the representative embodiments or the Examples of the present invention, but the invention is not limited to the embodiments and the Examples.

The benzoxazine compound of the present invention has a structure represented by formula (1).

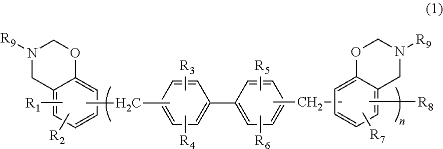

In formula (1), n is an average repeating number represented by a real number of 1 to 5, preferably a real number of 1 to 4, and more preferably a real number of 1 to 3.

In formula (1), R₁ to R₈ each independently represent a hydrogen atom, a halogen atom, an alkyl group having a carbon number of 1 to 8 or an aryl group; when n is 2 or more i.e. the number of each R₃ to R₇ is 2 or more, each R₃ to R₇ may be the same or different.

In formula (1), examples of the halogen atom represented by R₁ to R₈ include a fluorine atom, a chlorine atom, a bromine atom and an iodine atom.

In formula (1), the alkyl group having a carbon number of 1 to 8, which is represented by R₁ to R₈ is not limited to any linear, branched or cyclic alkyl groups. Examples of the alkyl group include a methyl group, an ethyl group, a n-propyl group, an iso-propyl group, a n-butyl group, an iso-butyl group, a tert-butyl group, a sec-butyl group, a n-pentyl group group, a n-hexyl group, a n-heptyl group, a cyclopentyl group, and a cyclohexyl group. A linear or branched alkyl group having a carbon number of 1 to 8 is preferred, and a linear or branched alkyl group having a carbon number of 1 to 4 is more preferred.

In formula (1), the aryl group represented by R₁ to R₈ is a residue of aromatic hydrocarbon from which a one hydrogen atom is removed and is usually an aromatic group having a carbon number of 6 to 16. Examples of the aryl group include a phenyl group, a biphenyl group, a naphthyl group, an anthryl group, a phenanthryl group, a pyrenyl group, a benzopyrenyl group and the like.

Preferably, each of R₁ to R₈ in formula (1) is independently a hydrogen atom, a halogen atom or a linear or branched alkyl group having a carbon number of 1 to 4, more preferably a hydrogen atom, a bromine atom or a linear alkyl group having a carbon number of 1 to 4, further preferably a hydrogen atom.

In formula (1), R₉ represents a residue of a monoamine compound from which an amino group is removed. Examples of the residue of a monoamine compound from which an amino group is removed include a hydrogen atom, a linear or branched alkyl group having a carbon number of 1 to 8, a cycloalkyl group having a carbon number of 6 to 8, and an aromatic group having a carbon number of 6 to 16. The alkyl groups and the aromatic groups may have one or more substituent groups.

Examples of the amine compound capable of forming the residue of a monoamine compound from which an amino group is removed, which is represented by R₉ in formula (1), include aliphatic monoamine compounds such as ammonia, methylamine, ethylamine, propylamine, butylamine, isopropylamine, hexylamine, octadecylamine, cyclohexylamine and the like; aromatic monoamine compounds such as aniline, 4-bromo aniline, toluidine, xylidine, anisidine, 1-aminonaphthyl, 1-amino anthracene, 4-amino benzaldehyde, 4-amino benzophenone, amino biphenyl and the like; 2-amino-5-bromopyridine, D-3-amino-ε-caprolactam, 2-amino-2,6-dimethylpiperidine, 3-amino-9-ethylcarbazole, 4-(2-aminoethyl)morpholine, 2-aminofluorene, 1-aminohomopiperidine, 9-aminophenanthrene, 1-aminopyrene and the like.

In formula (1), R₉ is preferably a residue of an aromatic monoamine compound or an alkylamine compound from which an amino group is removed, and more preferably a residue of an aromatic monoamine compound from which an amino group is removed.

The aromatic monoamine compound described above is preferably a residue of an aniline which may have one or more substituents or a biphenyl amine which may have one or more substituents, from which an amino group is removed, more preferably a residue of aniline which may have one or more substituents from which an amino group is removed, and further preferably a residue of aniline from which an amino group is removed (phenyl group). The alkyl amine compound described above is preferably an alkyl amine compound having a carbon number of 1 to 4.

Examples of the substituent(s) of the aniline which may have one or more substituents or the biphenylamine which may have one or more substituents described above preferably include an alkyl group having a carbon number of 1 to 4 or an alkoxy group having a carbon number of 1 to 4, more preferably, an alkyl group having a carbon number of 1 to 4. The number of the substituent(s) of the aniline which may have one or more substituents or the biphenyl amine which may have one or more substituents are usually 1 to 3, preferably 1 or 2.

The benzoxazine compound represented by formula (1) is preferably a compound where the bonding sites of two methylene groups which are connected to the biphenyl structure in formula (1) are 4 and 4′, i.e. the benzoxazine compound represented by formula (2) below is preferable.

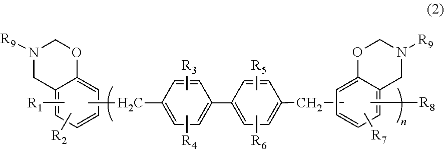

In formula (2), n and R₁ to R₉ represent the same as n and R₁ to R₉ in formula (1), and the preferred n and R₁ to R₉ in formula (2) are also the same as the preferred n and R₁ to R₉ in formula (1).

The benzoxazine compound represented by formula (1) of the present invention can be synthesized, for example, by the well-known method represented by the reaction formula below, with using a phenol compound represented by formula (3), a monoamine compound represented by formula (4) and an aldehyde compound as raw materials. In formula (3), n and R₁ to R₈ represent the same as n and R₁ to R₈ in formula (1). Also, in formula (4), R₉ represents the same as R₉ in formula (1). It has been explained in this description that R₉ in formula (1) represents a residue of a monoamine compound from which an amino group is removed. In this regard, the monoamine compound described above is meant to be the monoamine compound represented by formula (4). Note that formaldehyde is described as one of examples of the aldehyde compound in the reaction formula, but also paraformaldehyde, benzaldehyde and the like can be used.

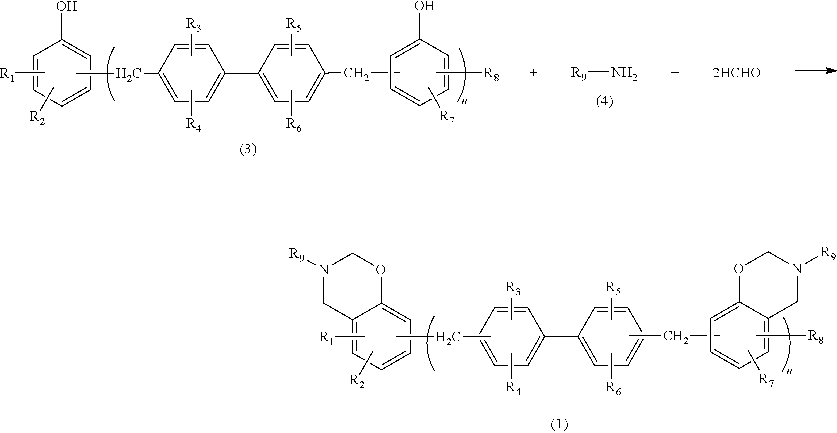

The ratio of the monoamine compound represented by formula (4) to 1 mol of phenolic hydroxyl group of the phenolic compound represented by formula (3) is preferably 0.5 to 1.2 mol, more preferably 0.75 to 1.1 mol. Also, the ratio of the aldehyde compound to 1 mol of the monoamine compound represented by formula (4) is preferably 1.7 to 4.3 mol, more preferably 1.8 to 4.2 mol.

The reaction may be conducted in a solvent or in absence of solvent. The solvent which can be used in the reaction is not specifically limited as long as the solvent can dissolve raw material compounds. Examples of the solvent include methyl ethyl ketone, toluene, 1-propanol, 2-propanol, 1-butanol, 1,4-dioxane, ethylene glycol monomethyl ether, ethylene glycol monoethyl ether, and ethylene glycol monobutyl ether. One of these solvents can be used simply, and two or more of the solvents can be used as a mixture.

As the reaction temperature, 60° C. or more is preferable. The reaction time is not specifically limited and can be appropriately selected with observing the progress of the reaction by seeing residual amounts of the raw materials used for the reaction.

When a solvent is used, the benzoxazine compound can be obtained by removing the condensed water produced during the synthesis, the residual raw materials, the solvent, and the like under reduced pressure after the completion of the synthesis. However, because the benzoxazine compound represented by formula (1) is self-curable, the temperature during the removal under reduced pressure is preferably 100° C. or less.

Hereinafter, specific examples of the benzoxazine compound represented by formula (1) are described, but the present invention is not limited to these examples. Note that n of the structural formula in the following examples represents the same as n in formula (1).

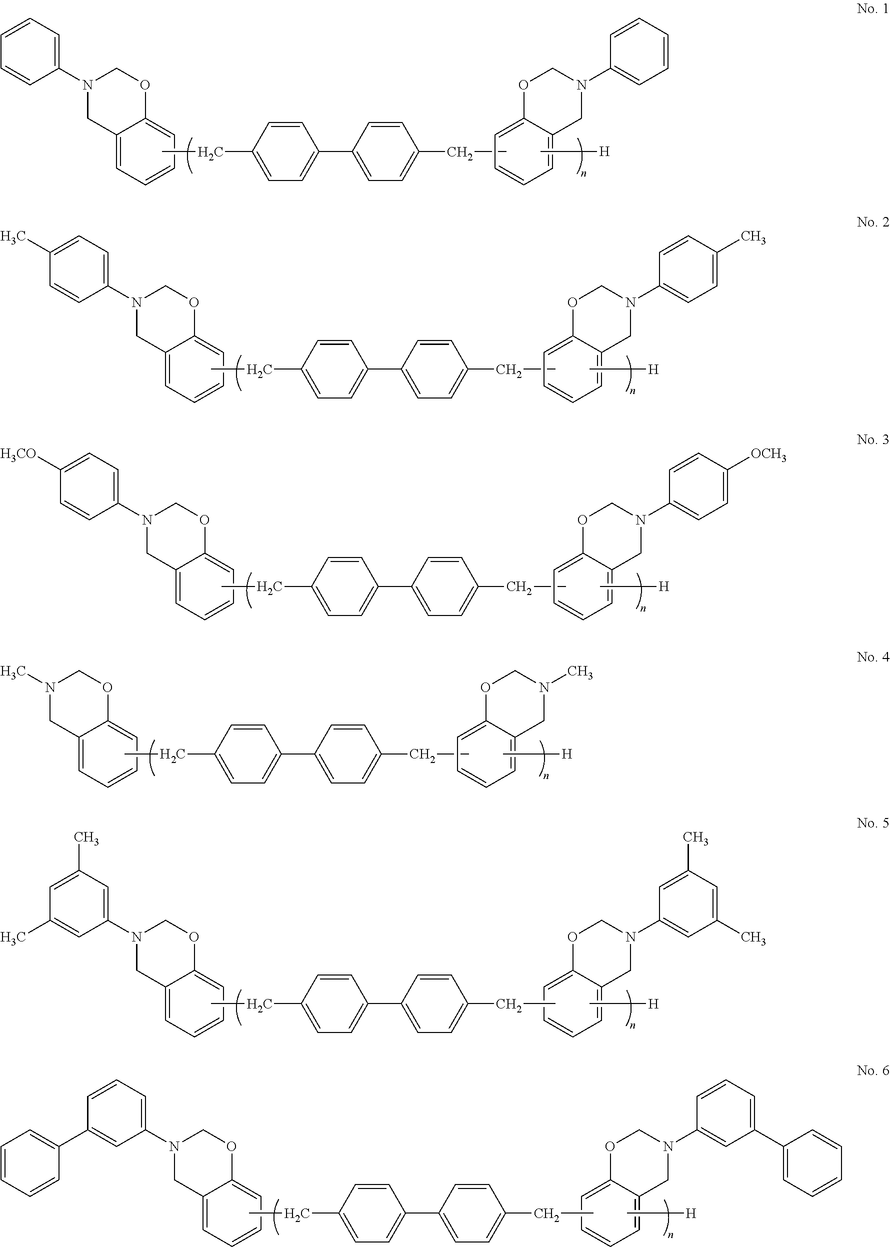

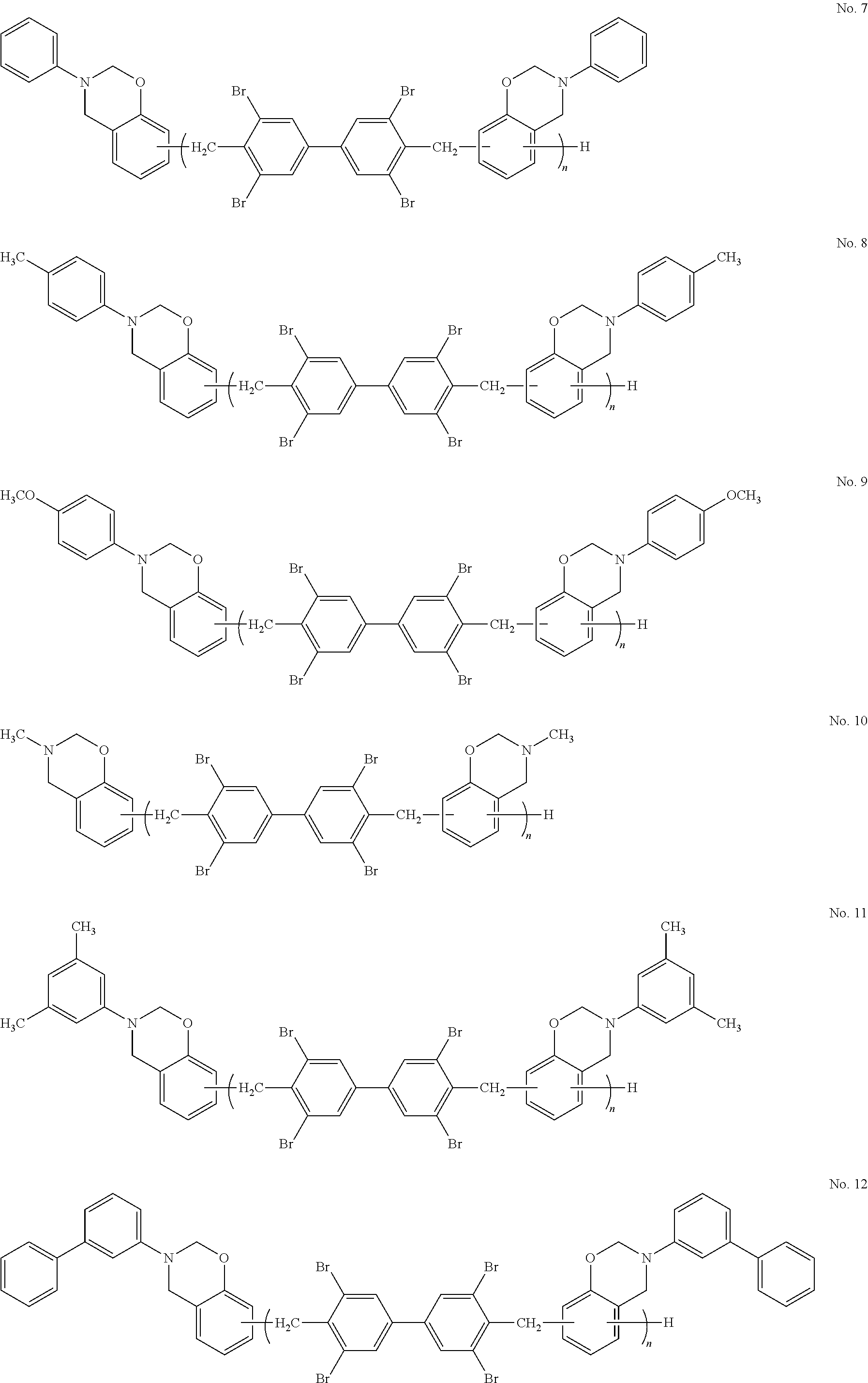

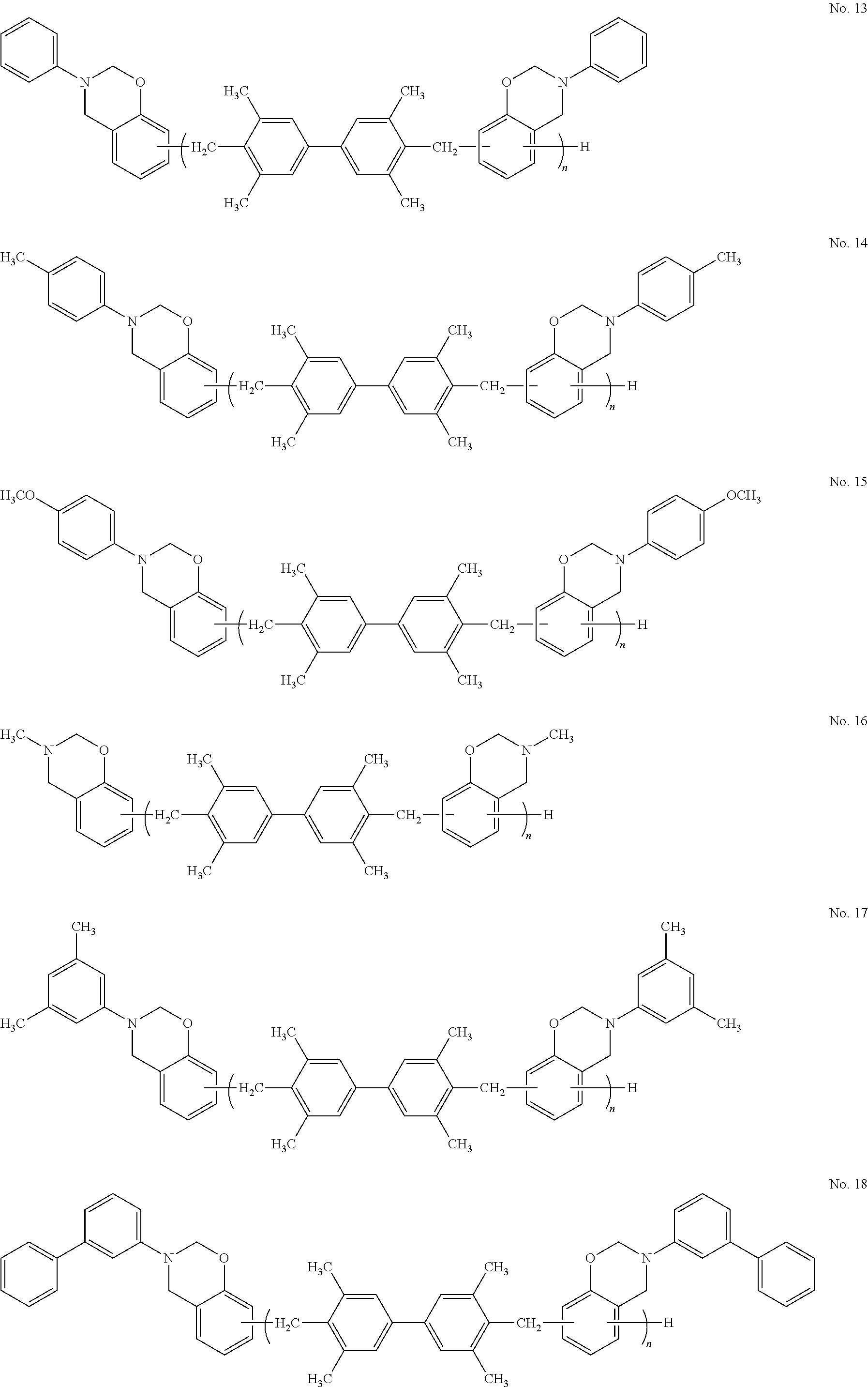

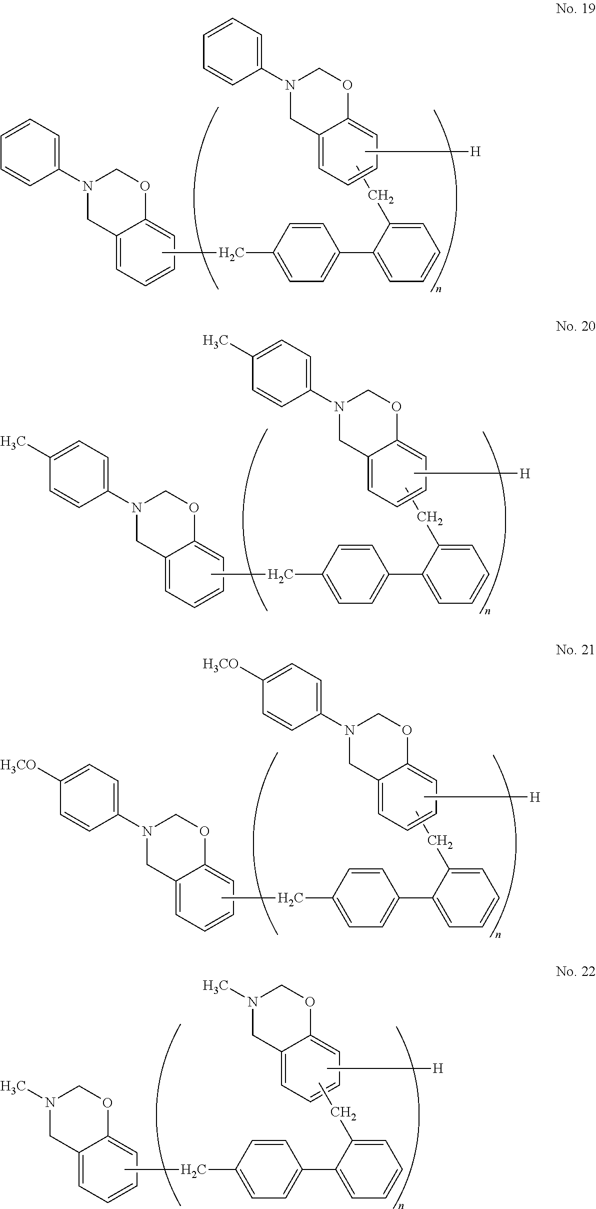

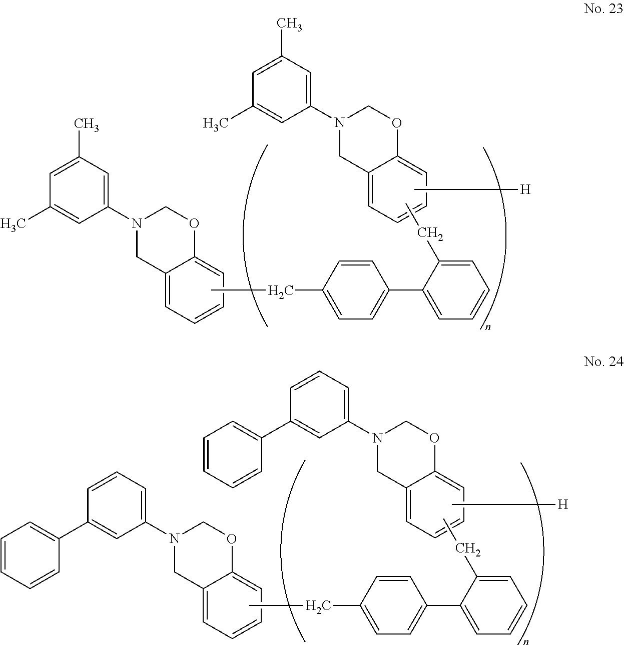

The benzoxazine compound represented by formula (1) of the present invention is self-curable (i.e. “self-curable” is meant to be that ring-opening polymerization (curing) can be conducted without other components such as a curing agent and a catalyst.) That is, because catalysts and the like are not needed in curing and by-products are not produced in polymerization process, the polymer (cured product) having high dimensional stability without void can be obtained. Regarding the conditions on the self-curing, the curing temperature is preferably 200° C. or more and the curing time is preferably from about several tens of minutes to several hours.

Note that when it is needed to reduce the polymerization (curing) temperature of the benzoxazine compound represented by formula (1) of the present invention, additives such as an inorganic acid, an inorganic base, an organic acid and an organic base may be blended.

Specific examples of these additives include hydrochloric acid, sulfuric acid, nitric acid, phosphoric acid, boric acid, sodium hydroxide, calcium hydroxide, sodium carbonate, potassium carbonate, formic acid, acetic acid, citric acid, oxalic acid, p-toluenesulfonic acid, benzoic acid, phenol, thiophenol, pyridine, trialkylamine, diazabicycloundecene, histidine and imidazoles. Among them, hydrochloric acid, p-toluenesulfonic acid, benzoic acid, phenol, thiophenol and 2-ethyl-4-methyl imidazole are preferred; and p-toluenesulfonic acid and 2-ethyl-4-methyl imidazole are more preferred. One of the additives can be used simply, or two or more of them can be used together.

The formulation amount of these additives may be appropriately selected depends on kinds or effects of them, however, the amount is preferably 50 parts by mass or less with respect to 100 parts by mass of the benzoxazine compound.

The benzoxazine compound represented by formula (1) of the present invention may be polymerized (cured) as needed by formulating optional components except for the additives described above. Examples of the optional components which can be used together include fillers, reaction retardants, age resistors, antioxidants, pigments (dye), flame retardants and antistatic agents.

Examples of the fillers which may be formulated include organic or inorganic fillers such as fumed silica, burning silica, sedimentation silica, crush silica, fused silica, diatomite, iron oxide, zinc oxide, titanium oxide, barium oxide, magnesium oxide, calcium carbonate, magnesium carbonate, zinc carbonate, pyrophyllite clay, kaolin clay, calcined clay and carbon black, which may have various shape. One of these additives can be used simply, or two or more of them can be used together.

Examples of the reaction retardants which may be formulated include compounds such as alcohols, and examples of the age resistors include compounds such as hindered phenols and the like. Also, the Examples of the antioxidant include butylated hydroxytoluene (BHT) and butylhydroxyanisole (BHA).

Examples of the pigments which may be formulated include an inorganic pigment such as titanium oxide, zinc oxide, sea blue, red ocher, lithopone, lead, cadmium, iron, cobalt, aluminum, hydrochloride salt, and sulfate; an organic pigment such as an azo pigment, a phthalocyanine pigment, a quinacridone pigment, a quinacridone quinone pigment, a dioxazine pigment, an anthrapyrimidine pigment, an anthanthrone pigment, an indanthrone pigment, a flavanthron pigment, a perylene pigment, a perinone pigment, a diketopyrrolopyrrole pigment, a quinonaphthalone pigment, an anthraquinone pigment, a thioindigo pigment, a benzimidazolone pigment and an isoindoline pigment and carbon black.

Examples of the flame retardant which can be formulated include a chloroalkyl phosphate, a dimethyl methyl phosphonate, a bromine compound, a phosphorus compound, an ammonium polyphosphate, a neopentyl bromide-polyether, and a brominated polyether.

Examples of antistatic agent which can be formulated generally include a quaternary ammonium salt; a hydrophilic compound such as a polyglycol and s ethylene oxide derivative.

The benzoxazine compound represented by formula (1) of the present invention may be polymerized (cured) by adding one or more copolymerization components such as an epoxy resin, a phenolic resin, a melamine resin, a unsaturated polyester resin, a polyimide resin, a polyamide resin, and a polyurethane resin. One of these copolymerization components can be used simply, or two or more of them can be used together.

In these copolymerization components, it is preferable to formulate an epoxy resin or a phenolic resin having the reactivity with the phenolic hydroxyl group which is provided in the benzoxazine compound represented by formula (1) of the present invention by heating. It is particularly preferred to formulate an epoxy resin.

An epoxy resin which can be formulated is not particularly limited as long as the epoxy resin has a compound having at least one epoxy group. Examples of the epoxy resin include a glycidyl ether types which are obtained by reaction of a polyhydric phenol such as bisphenol A, bisphenol F, bisphenol S, hexahydrobisphenol A, tetramethyl bisphenol A, pyrocatechol, resorcinol, cresol novolak, tetrabromobisphenol A, trihydroxy biphenyl, bisresorcinol, bisphenol hexafluoroacetone, tetramethyl bisphenol F, bixylenol, and dihydroxynaphthalene, with epichlorohydrin; polyglycidyl ether types obtained by reaction of an aliphatic polyvalent alcohol such as glycerin, neopentylglycol, ethylene glycol, propylene glycol, butylene glycol, hexylene glycol, polyethylene glycol, and polypropylene glycol, with epichlorohydrin; a glycidyl ether ester types obtained by reaction of a hydroxy carboxylic acid such as p-oxybenzoic acid, and β-oxynaphthoic acid, with epichlorohydrin; polyglycidyl ester types derived from a polycarboxylic acid such as phthalic acid, methyl phthalic acid, isophthalic acid, terephthalic acid, tetrahydrophthalic acid, hexahydrophthalic acid, endmethylene tetrahydrophthalic acid, endmethylene hexahydrophthalic acid, trimelitic acid, and polymerized fatty acid; glycidyl amino glycidyl ether types derived from aminophenol, and aminoalkyl phenol; glycidyl amino a glycidyl ester type derived from an aminobenzoic acid; a glycidyl amine type derived from aniline, toluidine, tribromoaniline, xylylene diamine, diaminocyclohexane, bisaminomethylcyclohexane, 4,4′-diaminodiphenylmethane, and 4,4′-diaminodiphenyl sulfone; also, epoxidized polyolefin, glycidyl hydantoin, glycidyl alkyl hydantoin, and triglycidylcyanurate.

The benzoxazine compound represented by formula (1) of the present invention can be also used as a varnish (resin varnish) which is dissolved in a solvent. It is preferred to use the benzoxazine compound represented by formula (1) as a varnish in terms of that the benzoxazine compound represented by formula (1) can be easily treated (handled).

Examples of solvents which can be used for the varnish of the present invention include toluene, xylene, acetone, methyl ethyl ketone, methyl isobutyl ketone, dimethylformamide, dimethyl acetamide, N-methylpyrrolidon, dioxane, 1-propanol, 2-propanol, 1-butanol, 1,4-dioxane, ethylene glycol ether, ethylene glycol monoethyl ether, ethylene glycol monobutyl ether, and propylene glycol monomethyl ether, but there is no specific limitation to use the solvent as long as the solvent can dissolve the benzoxazine compound represented by formula (1) of the present invention.

The varnish of the present invention may be formulated as needed with additives and optional components described above.

The polymer (cured product) of the benzoxazine compound represented by formula (1) can be obtained by applying the varnish comprising the benzoxazine compound represented by formula (1) of the present invention on a plate, removing (drying) the solvent at a temperature of, for example, 150° C. or less, and subsequently being subjected to treatment at a high temperature of 200° C. or more. Also, the prepreg which is obtained by removing the solvent after impregnation of glass nonwoven fabric with the varnish comprising the benzoxazine compound represented by formula (1), may be used as a fiber-strengthened material of a laminated plate and the like.

### EXAMPLES

Hereinafter, the present invention is described in detail by way of the Examples, but the present invention is not limited to the Examples. It should be noted that the term “part(s)” in the Examples means “part(s) by mass” unless otherwise noted.

### Example 1

A reactor of 20 ml equipped with a thermometer, a reflux condenser and a stirrer was charged with 2.0 parts of GPH-65 (This was a biphenyl phenol condensation type novolac resin which was a compound wherein R₁ to R₈ are hydrogen atoms and n is about 1.5 in the formula (3), manufactured by Nippon Kayaku Co., Ltd., hydroxyl equivalent: 200 g/eq.), 0.93 parts of aniline (manufactured by JUNSEI CHEMICAL CO., LTD.) and 1.0 parts of paraformaldehyde (manufactured by MITSUBISHI GAS CHEMICAL COMPANY, INC.). The reaction was performed for 30 minutes at 120° C. After the completion of the reaction, the reaction mixture was dissolved in 200 ml of chloroform and washed three times with 200 ml of 1 mol/L aqueous sodium hydroxide solution and 200 ml of ion exchanged water. After the completion of the washing, 1.65 parts (52% of yield) of the benzoxazine compound (No. 1 compound described above) represented by formula (5) below was obtained by dehydrating and drying under reduced pressure.

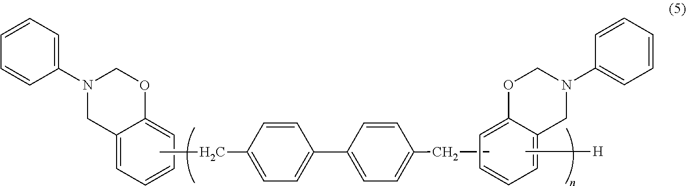

About a benzoxazine compound obtained by Example 1, structural determination was conducted by NMR. ¹H-NMR spectrum of the benzoxazine compound was shown in FIG. 2. From FIG. 2, it was confirmed that the benzoxazine compound has an objective structure which is shown in formula (5).

### Example 2

0.4 parts of the benzoxazine compounds obtained in Example 1 was dissolved in 0.6 parts of the NMP to obtain the resin varnish (Example 2)

### Comparative Example 1

0.4 parts of the benzoxazine compound (BA-BXZ, manufactured by Konishi Chemical Ind. Co., Ltd.) of the bisphenol A type shown in formula (8) below was dissolved in 0.6 parts of the NMP to obtain the resin varnish for the comparison (Comparative Example 1).

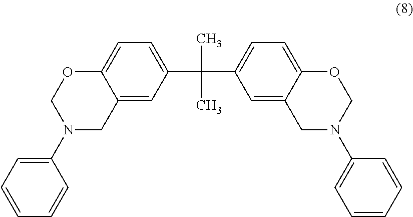 [SMILES: CC(C)(c1ccc2c(c1)CN(c1ccccc1)CO2)c1ccc2c(c1)CN(c1ccccc1)CO2]

### Example 3 and Comparative Example 2

Each of resin varnishes obtained in Example 2 and in Comparative Example 1 was applied on a glass plate so as to have a thickness of 30 μm after drying for 60 minutes at 120° C. Then, curing was conducted for 60 minutes at 240° C. to obtain cured films of the benzoxazine compound (Example 3) and the cured film of the benzoxazine compound for the comparison (Comparative Example 2).

### (Dynamics Characteristic Test)

For the cured films obtained by Example 3 and Comparative Example 2, dynamic characteristic tests were conducted by using a tensile testing device (AGS-X manufactured by SHIMADZU CORPORATION) which is set to be a tensile rate of 50 mm/m according to JIS K7161. The results were shown in Table 1.

### (Heat Resistance Examination)

For the cured films obtained by Example 3 and Comparative Example 2, the glass transition temperature Tg was measured by using a dynamic viscoelasticity measuring device DMS6100 (manufactured by Seiko Instruments Inc.). The results were shown in Table 1.

TABLE 1
[Evaluation Result]

| | | | Cured film | |
|---|---|---|---|---|
| | | | | Compar- |
| | | | Exam- | ative |
| Test name | Test item | Type | ple 3 | Example 2 |
| Dynamics | Tension test | Tensile elasticity | 2.3 | 3.3 |
| characteristic | | [GPa] | | |
| test | | Tensile stress | 66.0 | 37.0 |
| | | [MPa] | | |
| | | Rupture | 7.4 | 1.6 |
| | | elongation [%] | | |
| Heat resistance | viscoelasticity | Tg [° C.] | 277.0 | 171.0 |
| test | measurement | | | |
| | (DMA) | | | |

From the results shown in Table 1, it is obvious that the cured product of the benzoxazine compound of the present invention has superior toughness and heat resistance to the benzoxazine compound well known in the art.

### INDUSTRIAL APPLICABILITY

Because the benzoxazine compound of the present invention can afford a cured product having excellent toughness and heat resistance without using other components together, the benzoxazine is useful for applications such as a laminating board for a printing wiring board, or a semiconductor sealing material and the like.

1. A benzoxazine compound represented by formula (1): 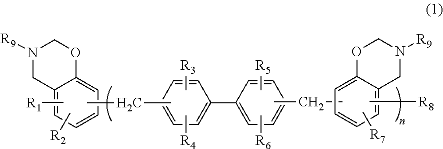
wherein, n is an average repeating number and represents a real number of 1 to 5; R₁ to R₈ each independently represent a hydrogen atom, a halogen atom, an alkyl group having a carbon number of 1 to 8 or an aryl group; when n is 2 or more and the number of each R₃ to R₇ is 2 or more, each R₃ to R₇ may be the same or different; and R₉ represents a residue of a monoamine compound from which an amino group is removed.

2. The benzoxazine compound according to claim 1, represented by formula (2): 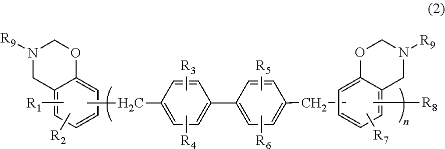
wherein, n and R₁ to R₉ represent the same as n and R₁ to R₉ in formula (1) described in claim 1.

3. The benzoxazine compound according to claim 1 or 2, wherein R₁ to R₈ are hydrogen atoms.

4. The benzoxazine compound according to any one of claims 1 to 3, wherein R₉ is a residue of an aromatic monoamine compound from which an amino group is removed.

5. A varnish comprising the benzoxazine compound according to any one of claims 1 to 4 and a solvent.

6. A cured product of the benzoxazine compound according to any one of claims 1 to 4.

7. A method of producing a benzoxazine compound represented by formula (1) according to claim 1 comprising the steps of:
reacting a phenolic compound represented by formula (3): 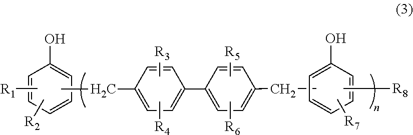
wherein, n and R₁ to R₈ represent the same as n and R₁ to R₈ in formula (1) described in claim 1,
with a monoamine compound represented by formula (4):
R₉—NH₂ (4)
wherein R₉ represent the same as R₉ in formula (1) described in claim 1,
and an aldehyde compound.
